(19) United States
(12) Patent Application Publication
(10) Pub. No.: US 2005/0186850 A1
(43) Pub. Date: Aug. 25, 2005

(54) HDMI plug connector

(76) Inventor: Wen-Hsien Tsai, Taipei Hsien (TW)

Correspondence Address: JOHNSON & ASSOCIATES, #282, 14625 BALTIMORE AVE, LAUREL, MD, 20707, US

(21) Appl. No.: 10/781,668

(22) Filed: Feb. 20, 2004

(51) Int. Cl. H01R 24/00

(52) U.S. Cl. 439/660

(57) ABSTRACT

The present invention provides a high definition multimedia interface (HDMI) connector, comprising an insulating housing, a terminal line separator, a metallic shell, a plurality of puncture terminals, a plastic outer shell and a front cover, wherein said terminal line separator consists of the terminal fixing plate and line binder, said puncture terminal is inserted in the insulated housing, the conduction lines are lined up on the line binder and punctured contact with the puncture terminals, followed by placing in the terminal fixing plate to secure the spacing among the puncture terminals, said metallic shell is consisted of the front and rear shell, wherein the insertion portion and the front metallic shell are further interlocked by use of the latch slot at the rear end of the metallic front shell and the latch lug on the insertion portion of the insulated housing, followed by incorporating the metallic rear shell to form a compact metallic unit, said metallic unit is then placed into the plastic outer shell, and the front cover is attached around the insertion opening of the front metallic shell, whereby the buckle on the front cover interlocks with a notch on the plastic outer shell, and the metallic unit is solidified inside the plastic outer shell, and the assembly of the HDMI plug connector is completed.

### BACKGROUND OF THE INVENTION

1. Field of the Invention

The present invention relates to a high definition multimedia interface (HDMI) connector, and more specifically to a small connector utilized in digital TV, DVD player, deck-top box (video signal converter), and other digital Audio/Video (AV) product.

2. Description of the Related Art

LCD in nowadays has become a most popular output device for Audio/Video (AV) product. Since it plays an important role in the products of modern PC monitor and TV display, and in the light of connector for digital signal transmission has become a mainstream product in LCD industries, the HDMI connector of the invention is thus created to serve this purpose.

The HDMI (High Definition Multimedia Interface) is a transmission interface utilized for the transmission of a high definition multimedia digital signal including high fidelity image and multi-channel audio signal. The earliest specification of the HDMI was established by several Audio/Video industries, such as HITACHI, Panasonic, Philips, Sony, Silicon Image, Thomson and Toshiba. It established the most frequently used standard specification based on DVI (Digital Visual Interface) for digital image signal transmission. The object of the invention is to transmit a digital screen signal between PC and LCD and display a live scene on LCD with high fidelity. Furthermore, the digital image signal transmitted by DVI also provides the effect of unauthorized copy proof, and its signal may be encoded at the transmitting end and decoded at receiving end that will provide the effect of preventing unauthorized reproduction of the image signal being transmitted. Although DVI improved the resolution and quality of picture on a LCD screen, however, DVI is not absolutely perfect, because it didn take the transmission of digital audio signal into account so far, therefore users need to connect additional line or use traditional AV terminal for signal transmission. This may not raise the question of compatibility among the signal transmissions in the application of personal computer, but it does cause chaos when used in the family theater set which is getting more and more popular among the consumers. Furthermore, as the digital products such as digital video camera and digital electronic camera are prevailed, it may become bothersome that if LCD TV requires a plurality of connection lines. This may also increase the number of installation components for family theater set, and further increase the price of product. Therefore, the HDMI of the present invention is thus created for family theater set to eliminate the flaws of DVI mentioned above.

The HDMI of the present invention is not only in compliance with the standard specification of DVI but also take digital audio signal into account in the design of HDMI connector, which is not only fully compatible with DVI but also capable of transmitting uncompressed data of digital AV signal without distortion. Furthermore, the HDMI also has advantages, such as, it complies with all kinds of video format specification used in the market, thus, it is capable of communicating with all kinds of product by all kinds of video transmission formats. Therefore, the HDMI provides the best quality and high fidelity video signal for consumer AV products, and because it supports all kinds of transmission format of digital video signal, resulted in less cable and smaller connector for the transmission of uncompressed data. Furthermore, the HDMI also succeeded the feature of unauthorized copy proof of DVI. It will alleviate the burden of movie filmmakers worrying that the export of the highest quality video products will come across with unauthorized reproduction by piracy. The HDMI connector also provides two-way communication for digital TV, DVD player, deck top box (signal converter) and other small connectors of digital AV products. The advantage is that the player provides the best image quality through determining which format is suitable for the received signal automatically. The HDMI connector is more convenient to install inside different AV products, because it is designed to reduce the volume of interface connector significantly.

It is known from the mentioned above that the HDMI will be a mainstream connector for AV product in the future. The HDMI will be the first AV standard specification supported throughout the software supplier and system provider to CE (Consumer Electronics) makers in a chain link. Therefore, the HDMI connector needs to be built with a strong construction to comply with the demand of high speed transmission. The object of the invention is to provide such new type of connector construction for the newly developed system.

### SUMMARY OF THE INVENTION

The main object of the invention is to provide a HDMI plug connector utilizing a terminal line separator to fix the contact of the puncture terminal and the conductor, and maintaining an equal space between each terminal to increase its stability and provide a stable signal communication.

Another object of the invention is to provide a HDMI plug connector wherein the front and rear shell adapted to cover the insulated housing may perform a quick engagement through its mating structure of the protrusions and the latch hole on the front and rear shell respectively.

A further object of the invention is to provide a HDMI plug connector wherein the plastic outer shell and front cover adapted to accommodate the main part of the integration body of the front and rear shell may also perform a quick engagement through its mating structure of the notch and the buckle on the front and rear shell respectively.

And still another object of the invention is to provide a HDMI plug connector, which adopts a punctured conductive contact in lieu of conventional soldering to alleviate environmental contamination problem.

To achieve above objects, a HDMI plug connector in accordance with the present invention comprises an insulated housing, a terminal line separator, a metallic cover shell, a plurality of puncture terminals, a plastic outer shell, and a front cover, wherein the terminal line separator further consists of a terminal fixing plate and a line binder.

When the puncture terminal is inserted in the insulated housing, the conduction lines are lined up on the line binder and punctured contact with the puncture terminalsthe, followed by placing in the terminal fixing plate to secure the spacings among the puncture terminals.

When the insulated housing and terminal line separator are integrated as an assembled part and inserted through the insertion opening of the front metallic shell, and the assembled part and the front metallic shell are further interlocked by use of the latch slot at the rear end of the metallic front shell and the latch lug on the insertion portion of the insulated housing, followed by incorporating the metallic rear shell by use of the protrusion on the metallic front shell and the latch hole on the metallic rear shell to form a compact metallic unit.

When the integrated assembly and the metallic rear shell are combined, the inward projections of the both sides of the metallic rear shell retaining the end side of the metallic front shell fittingly to prevent the metallic front shell from further movement during assembling operation.

Finally the metallic unit is placed into the plastic outer shell, and the front cover is attached around the insertion opening of the front metallic shell, whereby the buckle on the front cover interlocks with a notch on the plastic outer shell, and the metallic unit is solidified inside the plastic outer shell, and the assembly of the HDMI plug connector is completed.

The present invention will be readily apparent to those skilled in the art upon reading the following description of a preferred embodiment of the present invention and upon reference to the accompanying drawings.

### DETAILED DESCRIPTION OF THE PREFERRED EMBODIMENTS

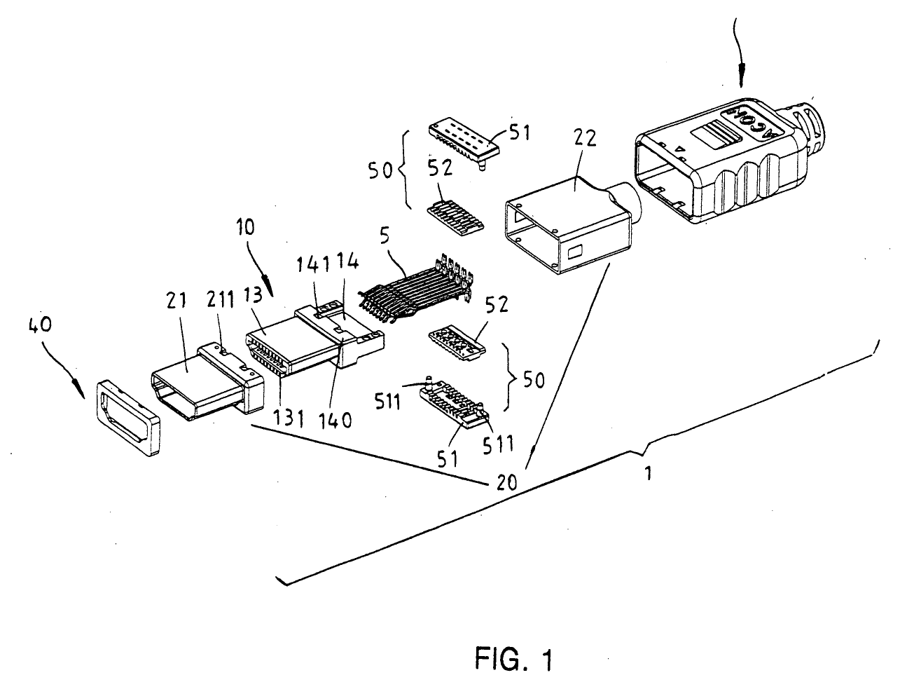

With the reference to FIG. 1, wherein a HDMI plug connector 1 comprises an insulated housing 10, a metallic cover shell 20, a plastic outer shell 30, and a front cover 40, wherein the structure of the insulated housing 10 consists of an insertion front 13 at front part and a retaining platform 14 at rear part, furthermore, the insulated housing 10 also provides an insertion holder for the terminal 5.

The insertion front 13 is a flat projected body, which provides two rows of terminal receiving slots 131 aligned at its top and bottom side extended throughout the portion from the insertion front 13 at the front part to the retaining platform at the rear part, and utilizes the curved contour shape at the bottom of both sides of the projected body to form an error proof design.

The retaining platform 14 is formed mainly by a horizontal T shape block combined with the insertion front 13, and a plurality of protrusions 141 are furnished on the top and bottom ends for interlock with the latch slot 211 on the metallic front shell, wherein the flat part of the horizontal T shape block forms the retaining platform, and the top and bottom sides of the retaining platform 14 provide a seat for the terminal line separator 50, and a plurality of concaves 151 on the top and bottom sides of the positioning block 15 at the both sides of the retaining platform 14 are furnished for insertion of the positioning pole 511 of the terminal fixing plate 51 of the terminal line separator 50.

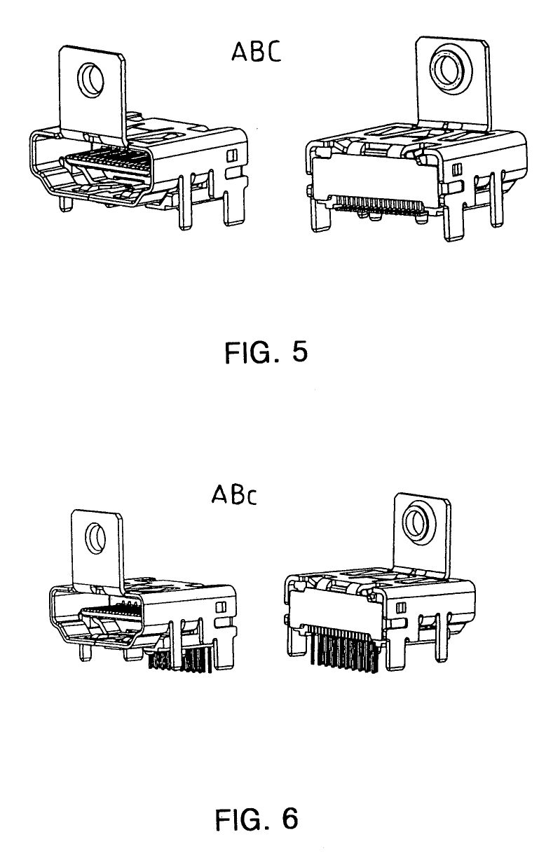

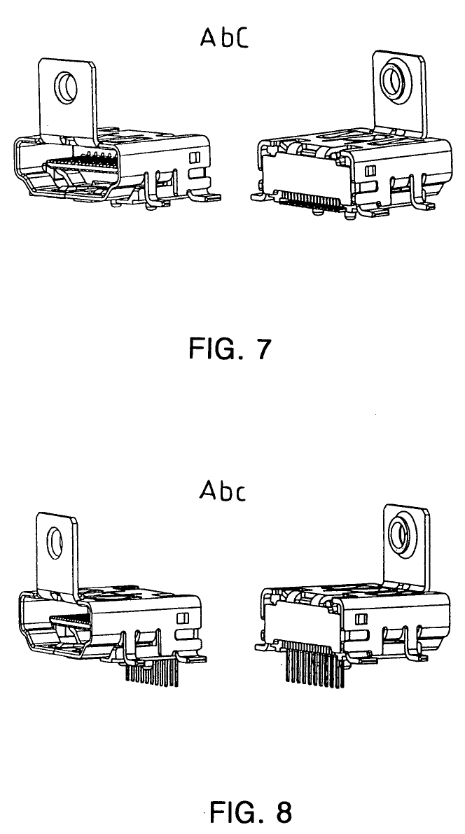

Referring to FIG. 4 and FIG. 5, the terminal line separator 50 consists of the terminal fixing plate 51 and line binder 52, which are mated with each other in a convex and concave area, wherein a plurality of the ribs 522 of different width are furnished on the inner side surface near the end sections of both long sides of the line binder 52, which keep in line with the same spacing between each rib 522 for receiving the fixing protrusion 512 of the terminal fixing plate 51, and the rib 522 has a step like profile in order to interlock each other firmly.

A Plurality of the arc portions 523 are formed between the ribs 522 of the both sides of the line binder 52, and each arc portion 523 adjoins the rib 522 at both sides to receive the placed lines. The positioning slot 524 are furnished with a insertion position fed through the arc portions 523 and the ribs 522 for the puncture terminals 5 to sit in, wherein the positioning slot 524 interlaces with the insertion position of the puncture terminals 5. The projection 525 placed on the long side end of the outside surface of the line binder 52 has the same height as the convex poles 526, which are placed between two rows of positioning slots 524, and the height of the projection 525 approximately equals to the thickness of the puncture terminal 5.

A plurality of the fixing protrusions 512 of different thickness aligned in a row with the same spacing 515 formed therein on the inner side surface near the end sections of both long sides of the terminal fixing plate 51 for receiving conduction lines, and each fixing protrusion 512 extended sideward from top forms a profile of arrow, wherein a plurality of the fixing insertion slots 514 are furnished on the concave section 513 formed between the fixing protrusions 512 of the terminal fixing plate 51 for insertion of the puncture terminals 5, and the position of the insertion slot 514 is interlaced corresponding to the position of the puncture terminal 5. Two positioning poles 511 are provided in diagonal on each short side of the fixing protrusion 512 and tightly mated with the concave 151 on the insulated housing 10.

The metallic cover shell 20 consists of the front and rear part, wherein the appearance of the metallic front shell 21 is similar to the insertion front 13 of the insulated housing 10 for receiving the insertion front 13, and the metallic front shell 21 is furnished with a plurality of the latch slot 211 and the lugs 212 on the top and bottom of the long side surface, whereby the latch slot 211 interlocks the protrusion 141 on the retaining platform 14 of the insulated housing 10, and the lugs 212 interlock the latch holes 221 on the metallic rear shell 22.

The metallic rear shell 22 of a rectangular body having a front hollowed opening attaches a hollowed cylindrical tube at the rear end to provide a sufficient inner space for receiving the conduction line. The positions of the latch holes 221 furnished on the front end of the metallic rear shell 22 are in correspondence with the position of the lugs 212 on the metallic front shell 21. The stops 222 furnished on a suitable spot of both sides of the narrow plate of the metallic rear shell 22, which may prevent a further movement by use of an inward slant stop 222 thrusting against the side edge of the rectangular section of the accommodated metallic front shell 21.

The plastic outer shell 30 is adapted for receiving the metallic rear shell 22 incorporated with the metallic front shell 21 and firmly housing the metallic rear shell 22. There is a plurality of notches 31 on the front end of the top and bottom sides of the plastic outer shell 30, and the number and position of the notches 31 correspondingly match the same of the buckles 41 on the front cover 40.

The front cover 40 has an opening similar to the insertion portion 11 and metallic front shell 21, so it may confine the front part of the metallic front shell 21 and thrust against the metallic front shell 21 at the rectangular section of the metallic front shell 21, and a plurality of buckles 41 are furnished on the top and bottom sides of the frame of the front cover 40.

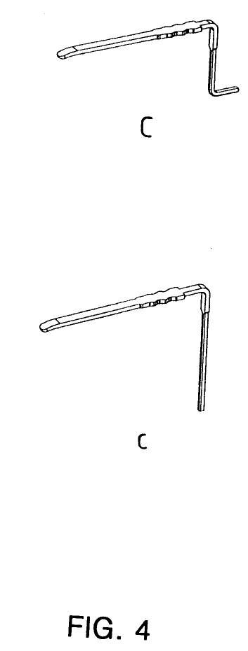

With the reference to FIG. 3, the puncture terminal 5 is formed by punching a flexible conductive material into a strip, whereby the base 501 extends to the two ends to form one end as an inserting contact portion and the other end as a conduction line contact portion. The inserting contact portion has a plurality of tooth spike 502 for use of fixing terminals, and on the opposite side of the tooth spike 502 a flexible contact 503 is formed with a curvature at its end, furthermore, at the end of the conduction line contact portion there is formed a line puncture 504 with a U-shape for easy puncture of conduction lines.

The assembly process of the preferred embodiment of the present invention is carried out from inside out. The first step of assembly is to introduce the conduction lines into the plastic outer shell 30 and rear metallic end shell 22, followed by inserting the puncture terminal 5 into the terminal position slot 131 inside the insertion front 13 of the insulated housing 10. On the other hand, the puncture line holder 504 of the puncture terminal 5 is then inserted into the positioning slot 524 of the line binder 52 in the terminal line separator 50, which in turn is placed on the retaining platform 14 of the insulated housing 10 for the conduction lines to be punctured by the puncture line holder 504 of the puncture terminal 5.

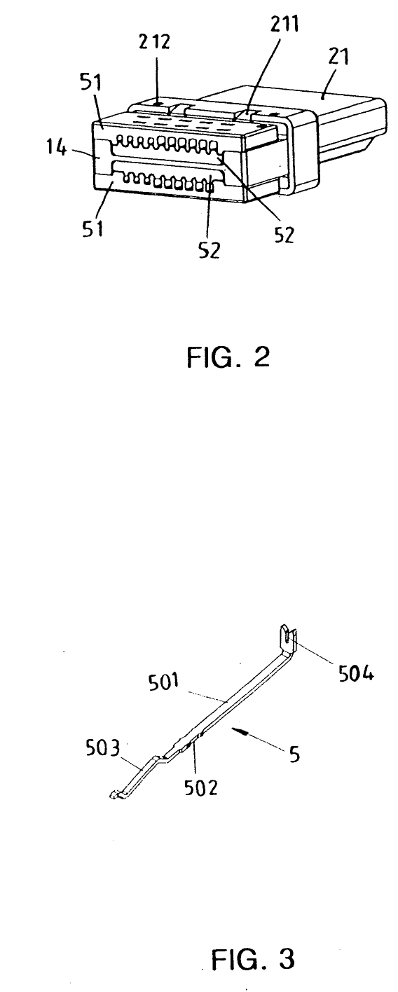

The conduction lines are routed through the arc portion 523 of the line binder 52, and then the terminal fixing plate 51 is firmly mated with the line binder 52 to bind the puncture line holder 504 of the puncture terminal 5 tightly and secure its spacings among terminals, whereby the conduction lines are tightly kept within the terminal line separator 50 through binding action of the line binder 52 and the fixing plate 51. And when the positioning pole 511 of the terminal fixing plate 51 is mated with the concave 151 of the insulated housing 10, the insulated housing 10 is fastened by the terminal line separator 50 and the terminals are held tightly within, and the first step of assembly is thus completed as shown in FIG. 2.

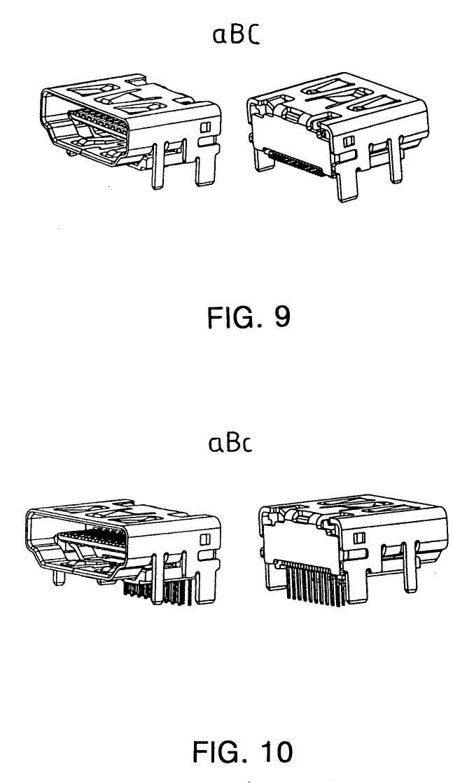

The second step of assembly is firstly to integrate the metallic front shell 21 with the assembled part in the first step mentioned above, wherein the latch slots 211 on the rectangular section of the metallic front shell 21 incorporate with the latch lugs 141 of the retaining platform 14 of the insulated housing 10 and the metallic front shell 21 is thus integrated with the assembled part, followed by inserting the integrated part into the metallic rear shell 22 which the cable wire is to be introduced in through the cylindrical end. The lugs 212 on the rectangular section of the metallic front shell 21 are latched with latch holes 221 on the metallic rear shell 22, therefore, the metallic front and rear shell 21, 22 are prevented from further movement during assembling operation by use of an inward slant stop 222 on both sides of the metallic rear shell 22 thrusting against the side edge of the rectangular section of the accommodated metallic front shell 21, and the second step of assembly is thus completed as shown in FIG. 6.

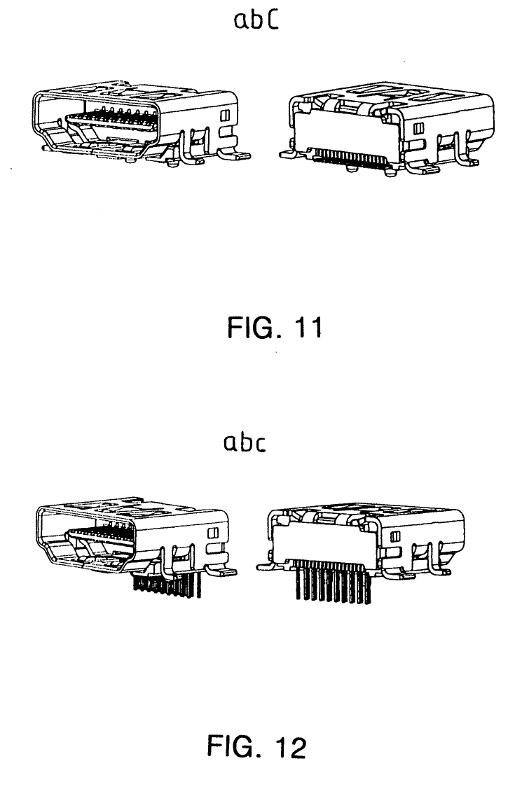

The third step of assembly is to engage the front cover 40 enclosing around the previously assembled metallic front shell 21 in the metallic housing assembly 20 to retain the rectangular section of the metallic front shell 21, and then move the assembled part into the plastic outer shell 30 which the cable wire is to be introduced in through the cylindrical end. Finally, the whole assembly of metallic housing assembly 20 is fixed firmly in the plastic outer shell 30 by use of the buckle 41 on the front cover 40 latched with the notch 31 of the plastic outer shell 30, and the complete assembly of the connector is accomplished as shown in FIG. 7.

From the above description it is understood that the HDMI connector of the present invention is thus fabricated and assembled through a multiple locking mechanism to form a rigid and compact structure in compliance with the strict requirements.

Although the present invention has been described with reference to a preferred embodiment thereof, it is apparent to those skilled in the art that there are a variety of modifications and changes that may be made without departing from the scope of the present invention which is intended to be defined by the appended claims.

1. A HDMI plug connector comprises an insulated housing, a terminal line separator, a metallic cover shell, a plurality of puncture terminals, a plastic outer shell, and a front cover, characterized in that the terminal line separator further consists of a terminal fixing plate and a line binder, when the puncture terminal is inserted in the insulated housing, the conduction lines are lined up on the line binder and punctured contact with the puncture terminals, followed by placing in the terminal fixing plate to secure the spacings among the puncture terminals.

2. A HDMI plug connector as in claim 1, wherein when the insulated housing and terminal line separator are integrated as an assembled part and inserted through the insertion opening of the front metallic shell, and the assembled part and the front metallic shell are further interlocked by use of the latch slot at the rear end of the metallic front shell and the latch lug on the insertion portion of the insulated housing, followed by incorporating the metallic rear shell by use of the protrusion on the metallic front shell and the latch hole on the metallic rear shell to form a compact metallic unit.

3. A HDMI plug connector as in claim 2, wherein the metallic unit is placed into the plastic outer shell, and the front cover is attached around the insertion opening of the front metallic shell, whereby the buckle on the front cover interlocks with a notch on the plastic outer shell, and the metallic unit is solidified inside the plastic outer shell, and the assembly of the HDMI plug connector is completed.

4. A HDMI plug connector as in claim 1, wherein the insulated housing consists of an insertion front at front part and a retaining platform at rear part, and the insulated housing also provides an insertion holder for the puncture terminal, wherein the insertion front is a flat projected body, which provides two rows of terminal receiving slots 131 aligned at its top and bottom side extended throughout the portion from the insertion front 13 at the front part to the retaining platform at the rear part, and utilizes the curved contour shape at the bottom of both sides of the projected body to form an error proof design.

5. A HDMI plug connector as in claim 4, wherein the retaining platform is formed mainly by a horizontal T shape block combined with the insertion front, and a plurality of protrusions are furnished on the top and bottom ends for interlock with the latch slot on the metallic front shell, wherein the flat part of the horizontal T shape block forms the retaining platform, and the top and bottom sides of the retaining platform provide a seat for the terminal line separator, and a plurality of concaves on the top and bottom sides of the positioning block at the both sides of the retaining platform are furnished for insertion of the positioning pole of the terminal fixing plate of the terminal line separator.

6. A HDMI plug connector as in claim 1, wherein the terminal line separator consists of the terminal fixing plate and line binder, which are mated with each other in a convex and concave area, wherein a plurality of the ribs of different width are furnished on the inner side surface near the end sections of both long sides of the line binder, which keep in line with the same spacing between each rib for receiving the fixing protrusion of the terminal fixing plate, and the rib has a step like profile in order to interlock each other firmly.

7. A HDMI plug connector as in claim 6, wherein the projection placed on the long side end of the outside surface of the line binder has the same height as the convex poles, which are placed between two rows of positioning slots, and the height of the projection approximately equals to the thickness of the puncture terminal.

8. A HDMI plug connector as in claim 1, wherein a plurality of the fixing protrusions of different thickness aligned in a row with the same spacing formed therein on the inner side surface near the end sections of both long sides of the terminal fixing plate for receiving conduction lines, and each fixing protrusion extended sideward from top forms a profile of arrow, wherein a plurality of the fixing insertion slots are furnished on the concave section formed between the fixing protrusions of the terminal fixing plate for insertion of the puncture terminals, and the position of the insertion slot is interlaced corresponding to the position of the puncture terminal. Two positioning poles are provided in diagonal on each short side of the fixing protrusion and tightly mated with the concave on the insulated housing.

9. A HDMI plug connector as in claim 2, wherein the metallic cover shell consists of the front and rear part, wherein the appearance of the metallic front shell is similar to the insertion front of the insulated housing for receiving the insertion front, and the metallic front shell is furnished with a plurality of the latch slot and the lugs on the top and bottom of the long side surface, whereby the latch slot interlocks the latch lug on the retaining platform of the insulated housing, and the protrusion interlocks the latch holes on the metallic rear shell.

10. A HDMI plug connector as in claim 2, wherein the metallic rear shell of a rectangular body having a front hollowed opening attaches a hollowed cylindrical tube at the rear end to provide a sufficient inner space for receiving the conduction line, and the positions of the latch holes furnished on the front end of the metallic rear shell are in correspondence with the positions of the lugs on the metallic front shell, wherein the stops furnished on a suitable spot of both sides of the narrow plate of the metallic rear shell, which may prevent a further movement by use of an inward slant stop thrusting against the side edge of the rectangular section of the accommodated metallic front shell.

11. A HDMI plug connector as in claim 3, wherein the plastic outer shell is adapted for receiving the metallic rear shell incorporated with the metallic front shell and firmly housing the metallic rear shell, a plurality of notches are furnished on the front end of the top and bottom sides of the plastic outer shell, the number and position of the notches correspondingly match the same of the buckles on the front cover.

12. A HDMI plug connector as in claim 2, wherein the front cover has an opening similar to the insertion front and metallic front shell, so it may confine the front part of the metallic front shell and thrust against the metallic front shell at the rectangular section of the metallic front shell, and a plurality of buckles are furnished on the top and bottom sides of the frame of the front cover.

13. A HDMI plug connector as in claim 1, wherein the puncture terminal is formed into a strip by punching a flexible conductive material, whereby the base extends to the two ends to form one end as an inserting contact portion and the other end as a conduction line contact portion. The inserting contact portion has a plurality of tooth spike for use of fixing terminals, and on the opposite side of the tooth spike a flexible contact is formed with a curvature at its end, furthermore, at the end of the conduction line contact portion there is formed a line puncture with a U-shape for easy puncture of conduction lines.
